(19) United States
(12) Patent Application Publication
(10) Pub. No.: US 2009/0114068 A1
(43) Pub. Date: May 7, 2009

(54) Zero Hysteresis Electric Ratchet Socket Driver

(76) Inventor: Carl Eugene Lawrence, Boulder, CO (US)

Correspondence Address: CARL E. LAWRENCE, 2810 OLSON DRIVE, BOULDER, CO, 80303, US

(21) Appl. No.: 11/935,480

(22) Filed: Nov. 6, 2007

(51) Int. Cl. B25B 23/157; B25B 21/00; B25B 13/46

(52) U.S. Cl. 81/475; 81/57.11; 81/63.1

(57) ABSTRACT

The invention is an improved ratchet to drive sockets for the purpose of tightening or loosening threaded fastener. The invention contains an electric motor, battery and worm gear system to drive the sockets. The battery and motor are contained within the handle of the invention and are thus limited in size and power. A switch is also located on the handle and is used to activate the motor in the desired direction. The motor is powerful enough to drive most fasteners when the fasteners are somewhat loose, and as such the invention can drive the loose fasteners rapidly. At such times when the fasteners are snug or tight the invention will perform as a conventional ratchet. As the handle is pulled the worm and pion gears will lock and transmit the torque to the socket. As the handle is released the motor will drive the worm and spin the pion gear/socket and take up all of the slack. The invention operates as a zero hysteresis ratcheting socket driver when the fastener is snug and as an electrically powered ratchet when the fastener is loose. The invention is of superior advantage when used in confined spaces with limited access to the socket end and limited room to swing the handle end.

### CROSS-REFERENCE TO RELATED APPLICATIONS

60/866,435

### FEDERALLY SPONSORED RESEARCH

None

### SEQUENCE LISTING

None

### BACKGROUND

1. Field of Invention

This invention relates to hand tools used to apply torque to threaded fasteners, such as nuts and bolts, and more specifically to such tools that use a ratcheting means having an electric motor and a battery.

2. Description of Prior Art

The prior art consists of many electrically and pneumatically driven hand tools such as wrenches, screw drivers, drills and ratchets. Some such tools are battery powered and some are powered by AC line voltage. In known cases there is either an electric motor or a force pulsing means used to produce the torque to drive the sockets fitted to the bolts and nuts. Most commonly, the electric motor drives through spur gears to reduce the motor speed to a predetermined fastener driving speed.

The challenge in designing most of the prior art tools is to produce enough torque at the output shaft. The electric motors need to be large, and presumably heavy, in order to produce useful torque. For battery powered versions of these tools, the larger motors require larger, and heavier, batteries. The large motors and large batteries required generally lead to a very large, heavy hand tool. Some devices use a force pulsing means such as a solenoid to produce the desired torque. These devices pulse and produce an impacting force to drive the fastener.

The prior art also includes pneumatically driven hand tools—either in the form of pneumatic wrenches or pneumatic ratchets. The pneumatic ratchet, which relates to the invention, require an energy source in the form of an air compressor, usually driven by an AC electric motor. The pneumatic ratchet performs the required tasks well by providing sufficient torque and speed to handle most jobs. Only when the fastener is very tight is the torque delivered by the pneumatic ratchet insufficient to move the fastener. In this situation the user will use the tool body length to apply the torque manually while relying on the mechanisms within the tool to lock the output shaft as the tool is being leveraged.

(Hand-held ratchet action tool) U.S. Pat. No. 6,178,643 (Erbrick, et al) describes a two jaw ratcheting device unrelated to an electrically powered hand-held ratchet used to drive nuts and bolts. (Drive assembly for an electric hand tool) U.S. Pat. No. 6,186,247 (Wang) discloses a ratchet tool which uses a motor driven rotor with two opposing prowls to engage the rotor. Several other U.S. patents for electrically driven wrenches and ratchets use an impact technology. It would appear that the convention is to use an impact technology in a effort to produce a strong torque with tools having limited motor power.

In conclusion, insofar as I am aware, there are no electrically driven ratchets that utilize a motor having limited torque and power, and rely upon the user to apply a higher torque when needed. Thus, there are no electric ratchets with small, efficient motor and battery combinations providing light weight and ease of use.

### SUMMARY

This invention is a tool used to drive sockets used in the tightening or loosing of mechanical, threaded fasteners. Said mechanical fasteners generally having a hexagonal or square head, or being a hexagonal or square nut. This invention is an improvement to the conventional, mechanical, hand pulled lever-arm ratchet, and also being an improvement to the conventional pneumatically driven ratchet.

The disclosed invention has the conventional topography of a ratchet drive wrench used with sockets to drive the mechanical threaded fasteners. The invention also contains an electric motor and an energy source such as a battery. Said motor is bi-directional and controlled through a bi-directional switch. The motor is connected to a shaft which, in turn, is connected to a worm gear. The worm gear drives a pion gear, and the pion gear is connected to the square drive output shaft to which sockets are attached during use.

The electric motor is sized to drive the socket with sufficient torque to lightly tighten the fastener. Said electric motor will be of a physical size as to fit inside of the ratchet handle and the handle will be of a physical size as to fit comfortably in a user's hand. With such a limitation of physical size the power of the motor will, in accordance, be limited.

A worm gear and pion can only transmit movement in one direction. A motor can drive the worm gear and the worm gear can drive the pion, but the pion will lock up against the worm gear if the pion gear is driven. Additionally, the worm gear and pion gear allow the motor speed to be reduced to drive the socket at a predetermined speed.

In operation, the user will attach a socket to the output shaft of the pion gear and place the socket on a fastener to tightened or loosened. The user will then press the switch to cause the socket to rotate in the desired direction. If the fastener is loose then the invention will drive the fastener rapidly in the desired direction using the power of the electric motor. When the fastener is snug or tight the motor will slow. As the motor becomes too slow to turn the fastener at a reasonable speed the user will then operate the invention is a conventional manner of a non-powered ratchet driver. The user will pull the handle as the pion gear is locked up against the worm gear. After a stroke the user will move the handle back, in a conventional ratcheting manner, and the motor will drive the worm gear, taking up any and all slack. This operation is repeated until the desired operation is completed.

In the application of a tight fastener where the user is attempting to loosen and remove said fastener, the invention can be employed. The user places the invention on the fastener and operates the switch for the desired direction of rotation. As the fastener is tight the invention is not expected to loosen the fastener through the power provided by the electric motor. The user will then manually pull, or push, the lever arm of the invention and, in this manner, loosen the fastener. At the point of full stroke of the invention, and assuming the fastener is still snug, the user will swing the invention in the opposite direction and the motor will drive the worm gear and keep the socket snug against the fastener with a predetermined torque. When the user reaches a full reverse stroke of the invention the user will again apply a pull, or push, in the desired direction. This action by the user will be repeated until the fastener is loose enough such that the power delivered by the motor is sufficient to rotate the fastener and rapidly spin the fastener until it is removed.

Additionally, when the invention is used in limited access locations two major benefits are realized. The first is the driving of a loose fastener in a confined space. When conventional ratchets are used in this situation there is quite often insufficient resistive torque of the fastener to operate the mechanical ratcheting mechanism. The fasten rotates in the desired direction when the ratchet handle is pulled, but then rotates back in the opposite direction when the handle is pushed. The fastener simply rotates back and forth with every movement of the conventional ratchet back and forth, achieving nothing. The conventional ratcheting means does not have enough resistive torque to operate. The invention will operate in this situation. As the electric motor is always applying a torque when the switch is activated, the loose fastener will spin in the desired direction without the movement of the invention body.

In the second situation of using the invention in a limited access location, the fastener is snug. When a conventional ratchet is used there may not be enough room to swing the lever arm back to the point where the next catch of the ratcheting means is achieved. As the lever arm of the conventional ratchet is moved back and forth at a small angle caused by the limited space, there is insufficient room for the ratcheting means to operate do to the mechanical ratchet's inherent hysteresis. The invention has zero hysteresis due to the motor and worm gear always driving and holding the output shaft in the desired direction. In this situation, even the smallest angular movement of the invention handle will drive the fastener in the desired direction.

Accordingly, it is an objective of the invention to provide a ratcheting tool having a drive means to automatically turn fasteners quickly at low torque loads.

It is a second objective of the invention to provide a ratchet tool having zero hysteresis for use in confined areas.

Still further objectives and advantages will become apparent from a consideration of the ensuing description and accompanying drawings.

### DRAWINGS

FIG. 1 is a transparent view of the invention showing the motor, battery and gears.

FIG. 2 is a view of the invention as used in a confined space.

### REFERENCE NUMERALS

10 body
12 motor
14 worm gear
16 pion gear
18 motor shaft
20 square output shaft
22 bi-directional switch
24 switch movement
26 battery
28 socket release button
30 lever arm
32 wires
34 forward motion
36 reverse motion
38 barrier

### DETAILED DESCRIPTION

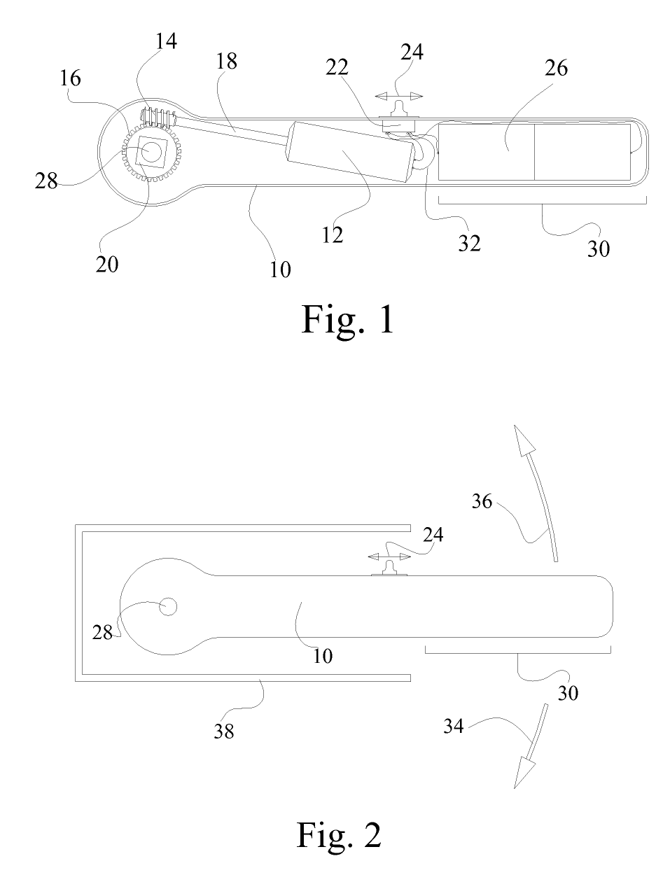

FIG. 1 and FIG. 2 illustrate a possible embodiment of the invention. Many other embodiments of the invention can be anticipated when based on the claims of this invention.

The invention has the conventional topography of a mechanical ratcheting tool used to drive a socket for the tightening and loosening of threaded fasteners, such as nuts and bolts. As shown in FIG. 1 the body 10 of the invention is used to enclose the components of the invention and to provide a means for applying a force to the invention. Within the body 10 is a battery 26, switch 22, motor 12, motor shaft 18, pion gear 16, worm gear 14, and the wires 32. The battery 26 is rechargeable and electrically connected to the motor 12 through a switch 22 via a set of wires 32. The motor 12 is connected to the worm gear 14 through a shaft 18. The worm gear 14 is in mesh with the pion gear 16. The pion gear 16 is connected to square output shaft 20, and onto the square output shaft 20 is where the sockets are installed as needed. There is also a conventional socket push release button 28 in the center of the square output shaft 20 to facilitate the release of sockets as required.

In FIG. 2 the invention is being used within the confines of a barriers 38. Within the confines of the barrier 38 the tool has only minimal movement in the forward motion 24 or the reverse motion 36. The force used to swing the invention will be applied to the lever arm 30.

### Operation

In FIG. 1 the invention body 10 contains the battery 26 which supplies electrical current to the electric motor 12. The direction of the current flowing through the motor is controlled by the bi-directional switch 22. The switch movement 24 determines which direction the current flows though the motor 12 and the direction the motor 12 will rotate. The motor 12 drives a motor shaft 18 rotationally and in the direction set by the switch movement 24. A worm gear 14 is fixed to the end of the motor shaft 18 opposite the motor 12. The worm gear 14 meshes with a pion gear 16. The worm gear 14 and the pion gear 16 can have Acme, square or any other thread type suitable for a worm and pion gear system. The pion gear 16 can rotate in the body 10 and has an output shaft 20 fixed to it. The output shaft 20 can receive a conventional socket used to drive square or hex nuts and bolts. The conventional sockets can be held to the output shaft 20 through the use of a locking means, which can be activated though the socket release button 28 as is common with many current ratchet tools.

The user of the invention will place a conventional socket on the output shaft 20 and place the socket on to the nut or bolt. If the fastener is loose the user will move the bi-directional switch 22 in a direction to cause the output shaft to rotate in the desired direction. Because the fastener is loose, the invention will be able to drive it in the desired direction even with the application of the limited power of the motor 12. The invention can thus drive the fastener in either direction as desired by the user.

If the fastener is not loose, the power supplied by the motor 12 and the battery 26 will not be sufficient to rotate the fastener. In such situations the user will set the switch movement 24 to the desired position and grip the lever arm 30 and pull or push in a forward motion 34 or a reverse motion 36, as the user desires. The pion gear 16 will not be able to rotate the worm gear 14 and the forward motion 34 or the reverse motion 36 supplied by the user can be sufficient to rotate the fastener. The user can continue to apply the forward motion 34 or the reverse motion 36 until the fastener is tight, as desired by the user, or the fastener is loose enough for the limited power of the motor 12 to rotate the fastener as the user desires.

As stated, when the fastener is too tight for the power of the motor 12 to rotate the fastener, then the user applies either a forward motion 34 or a reverse motion 36. As the user may reach the end a stroke of the lever arm 30, the user can move the lever arm 30 in the opposite direction and the motor 12 will be unloaded and rotate. This action will cause the worm gear 14 to rotate, in the desired direction as set by the switch movement 24, and maintain a gear-to-gear force against the pion gear. At the end of the back stroke of the lever arm 30 the user will again reverse the directional movement of the lever arm 30 and apply a rotating torque exerted against the fastener. With these actions the invention will act as a conventional ratcheting socket driver.

In such situations where the invention is being used as a conventional ratcheting socket driver it will function as a zero hysteresis ratchet. Because the worm gear 14 is driven against the pion gear 16 during a back stroke there is no hysteresis between the invention body 10 and the output shaft 20. And since a pion gear 16 can not drive a worm gear 14 the ratcheting will be locked as the torque is applied by the user through the lever arm 30.

### CONCLUSION, RAMIFICATION, AND SCOPE OF INVENTION

In conclusion the disclosed invention teaches a tool to be used to rotate threaded fasteners. The invention is a better tool to turn such fasteners in a confined space, both if the fastener is tight and if the fastener is loose. When the fastener is tight the invention acts as a zero hysteresis ratcheting socket driver and the pion gear 16 will lock up against the worm gear 14. The teeth of the pion gear 16 will transmit the torque to the teeth of the worm gear 14 and thus, eventually, to the body 10 and the lever arm 30. When the fastener is loose then the invention will act as an electrically powered ratcheting tool and spin the fastener as desired by the user.

Although the description above contains many specifications, these should not be construed as limiting the scope of the invention but merely providing illustrations of some of the presently preferred embodiments of this invention. Various other embodiments and ramifications are possible within it's scope. For example, additional gear systems can be utilized along with the worm gear system as a means to reduce the motor speed even more. Further, the bi-directional switch could be incorporated into a rotating means in the body in such a manner as to allow the user to simply twist the lever arm to activate the switch.

Thus the scope of the invention should be determined by the appended claims and their legal equivalents, rather than by the examples given.

I claim;

1. A ratcheting socket driver tool for applying a rotating torque to a threaded fastener, comprising:
a) a body of predetermined size and shape,
b) an electric motor,
c) a battery
d) a worm gear system

2. Said ratcheting socket driver tool as in claim 1, wherein said body has the topography of conventional, mechanical ratcheting socket drivers.

3. Said ratcheting socket driver tool as in claim 1, wherein said electric motor is controlled directionally with the use of a bi-directional switch.

4. Said ratcheting socket driver tool as in claim 1, wherein said battery is rechargeable.
